(19) United States
(12) Patent Application Publication
(10) Pub. No.: US 2022/0333578 A1
(43) Pub. Date: Oct. 20, 2022

(54) WIND POWER GENERATOR FOR STREET LIGHT

(71) Applicant: Yonggyu LEE, Yongin-si (KR)

(72) Inventor: Yonggyu LEE, Yongin-si (KR)

(21) Appl. No.: 17/642,995

(22) PCT Filed: Aug. 14, 2020
(86) PCT No.: PCT/KR2020/010875

§ 371 Date: Mar. 15, 2022

(30) Foreign Application Priority Data
Sep. 26, 2019 (KR) 10-2019-0119160

(51) Int. Cl. F03D 9/46; F03D 13/20; F03D 1/04; H02K 7/18; F21S 9/04

(52) U.S. Cl. CPC F03D 9/46; F03D 13/20; F03D 1/04; H02K 7/183; F21S 9/043

(57) ABSTRACT

The present invention relates to a wind power generator for street light comprising: a post member installed vertically; a central fixed shaft member installed horizontally on an upper portion of the post member; a first blade member rotatably installed around the central fixed shaft member and including a first blade rotated by wind on one side thereof; a second blade member rotatably installed around the first blade member and including a second blade rotated by wind on one side thereof; a cone member having an inclined shape at a specific angle so that wind smoothly moves toward the first blade member and the second blade member, and a power generation module rotated by the first blade member and the second blade member to generate power. According to the present invention, the first blade member and the second blade member can supply sufficient torque required for the rotation of the power generation module and can increase power generation time by driving the power generation module with the double blades. In addition, it is possible to minimize the installation space and reduce the size of the wind power generator by installing the first rotating shaft and the second rotating shaft in a double layer structure.

### FIELD OF THE INVENTION

The present invention relates to a wind power generator for street light, and more specifically, to a wind power generator for street light including a power generation module that is driven by double blades, which can provide sufficient torque for the power generation module and increase the rotation of the power generation module.

### BACKGROUND OF THE INVENTION

In general, wind power generation is a technology that converts wind's kinetic energy into electricity. A wind power generation system is composed of a mechanical device part, an electric device part, a control device part, and the like.

The mechanical device part consists of a rotor including a rotating blade and a rotating shaft that produce a rotational force from the wind, and a controller including a gearbox for converting the rotational force to moderate speed, a brake for starting, braking, and improving operation efficiency, a pitching system, and a yaw system.

The electric device part consists of a generator and other power stabilization devices to supply stable power.

The control device part consists of a control system that sets up and drives the wind power generation system in unmanned operation, a yaw controller that adjusts the direction of the blade to face the wind direction, a pitching controller that adjusts the tile angle, or the pitch, of the blade to actively control the output of the wind power generation system, and a monitoring system that enables a remote control and determines the system status on the ground.

Wind power generation system can be divided into a vertical axis generator and a horizontal axis generator depending on the direction of the rotation axis.

Since the vertical axis generator operates regardless of the wind direction, the vertical axis generator can be installed and used in deserts or plains. However, there are disadvantages in that the materials for building the vertical axis generator is expensive and the efficiency is lower than that of the horizontal axis generator.

On the other hand, since the horizontal axis generator has a simple structure, the horizontal axis generator can be easily installed. However, the horizontal axis generator is affected by wind direction. In general, the horizontal axis generator is used to produce electricity on a medium or large scale, and the vertical axis generator is used on a small-scale generation of 100 kW or less.

Meanwhile, wind power generation system can be divided into geared and gearless types according to the operation method.

Most wind power generation systems are geared wind generation systems using a constant-speed induction generation device, and are equipped with a gear device that increases the rotation speed of the rotor to match that of the induction generation device.

A gearless wind generation system uses a variable speed synchronous generation device, or a permanent magnet generation device, and is a direct-drive type in that the rotor and the generation device are directly connected to each other using a multipole synchronous generation device without a multiplying gear.

Although the gearless wind generation system has high power generation efficiency, it is more expensive and has a larger size than the geared wind generation system having an induction generation device.

Since a wind power generation system can produce more wind energy when the wind speed is higher and the size of the generator is larger, the amount of power generated by wind power generator depends on the strength of the wind and the size of the generator. In addition, since wind is strong at high altitudes, the generators installed at high altitudes are larger and generate more power than the generators installed at lower altitudes.

Meanwhile, wind power generation requires wind blowing at an average speed of 4 m/s or more. The requirement for wind speed refers to the speed at the height at which the blades of the wind generator are positioned, not on the ground.

As energy crisis and environmental pollution become serious problems due to the depletion of fossil fuels, technologies for generating electricity using clean energy such wind or tidal power are being developed in countries around the world.

Since the conventional wind power generator occupies large space, it is not suitable for use in a device having a relatively narrow space, such as a street light.

Therefore, there is a need for a novel wind power generator capable of generating sufficient power in a narrow place such as a street light.

For example, Patent Document 1 below discloses ‘Wind Power Generation System for Street Light.’

The wind power generation system for street light according to Patent Document 1 comprises: a stator fixed to an upper end of street light post, and a cylindrical rotor coupled to the upper portion of the stator. The stator may include: a post coupling part coupled to the upper end of the post; a post hub formed to protrude upward from the post coupling part; a core fixed to the outside of the post hub and formed in a hollow cylindrical shape, and a coil winding part formed to protrude radially to the outside of the core to have a coil wound thereon.

The rotor may include: a cap hub rotatably coupled to the stator by a bearing installed on the outer circumferential surface of the post hub of the stator; a cap connected to and fixed to the cap hub, and permanent magnets of N poles and S poles surrounding the core of the stator and disposed on the inner circumferential surface of the stator.

Multiple ring-shaped flanges are vertically coupled to the outer circumferential surface of the cap of the rotor at regular intervals, and a blade fixing piece is fixed to the flange so that the blade is fixed to the blade fixing piece.

Patent Document 2 below discloses ‘Generator for Street Light.’

The generator for street light according to the Patent Document 2 includes: a wind power generation part coupled to an upper portion of street light post and having a blade, and a solar power generation part coupled to the wind power generation part. The wind power generation part includes: a support frame; a stator frame coupled to the upper portion of the support frame, and a rotor frame rotatably coupled to an upper portion of the stator frame.

The support frame is a hollow member, and includes: a support flange formed on the lower portion of the hollow member and having a bolt hole; a flange formed on the upper portion of the street light post to couple to the support flange with a bolt; a seating plate formed on the upper portion of the hollow member, and a plurality of reinforcing ribs integrally formed on the outer circumferential surface of the hollow member.

The stator frame may include: a fixing plate having a disk shape; a hollow fixing member formed in the lower portion of the center of the fixing plate and having a withdrawal hole; a hollow guide member corresponding to the hollow fixing member and formed on the upper portion of the fixing plate; a stator coupled to a fixing piece protruding from the upper portion of the fixing plate; a cable withdrawal hole formed inside the fixing piece, and a support member integrally formed between the cable withdrawal hole and the hollow guide member.
Patent Document 1 Korean Patent Registration No. 10-0958669
Patent Document 2 Korean Patent Registration No. 10-0968777
Patent Document 3 Korean Patent Publication No. 10-2013-0003788

### DETAILED DESCRIPTION OF THE INVENTION

### Technical Problems

The object of the present invention is to solve the problems mentioned above and to provide a wind power generator for street light that can drive a power generation module by double blades.

Another object of the present invention is to provide a wind power generator for street light that can provide sufficient torque for the power generation module and can increase the rotation speed of the power generation module by using the double blades.

Another object of the present invention is to provide a wind power generator for street light that can guide the wind toward the double blades to generate power consistently.

### SUMMARY OF THE INVENTION

To achieve the object mentioned above, a wind power generator for street light according to the present invention comprises: a post member 10 installed vertically; a central fixed shaft member 20 installed horizontally on an upper portion of the post member 10; a first blade member 30 rotatably installed around the central fixed shaft member 20 and including a first blade 33 rotated by wind on one side thereof; a second blade member 40 rotatably installed around the first blade member 30 and including a second blade 43 rotated by wind on one side thereof; a cone member 50 having an inclined shape at a specific angle so that the wind smoothly moves toward the first blade member 30 and the second blade member 40, and a power generation module 60 rotated by the first blade member 30 and the second blade member 40 to generate power.

The post member 10 may include: a lower post 11 formed to a predetermined height; a lower flange 12 formed on a top side of the lower post 11 with a predetermined diameter; an upper post 13 installed on the top side of the lower post 11; an upper flange 14 formed on the bottom side of the upper post 13 with the same diameter as the lower flange 12, and a flange cover coupled to the outer surface of the lower flange 12 and the upper flange 14, wherein the upper post 13 is rotatably installed around the lower post 11.

The first blade member 30 may include: a first rotating shaft 31 rotatably installed around the central fixed shaft member 20; a first rotating plate 32 formed of a disk having a predetermined diameter and installed at one end of the first rotating shaft 31; a plurality of the first blades 33 formed to protrude from an outer circumference of the first rotating plate 32 to be rotated by wind moving along the cone member 50; a first rotating gear 34 formed at the other end of the first rotating shaft 31 rotated by the first blades 33, and a second rotating gear 35 installed to be engaged with the first rotating gear 34 to rotate the power generation module 60.

The second blade member 40 may include: a second rotating shaft 41 rotatably installed around the first rotating shaft 31; a second rotating plate 42 formed of a disk having a predetermined diameter and installed at one end of the second rotating shaft 41; a plurality of second blades 43 formed to protrude from an outer circumference of the second rotating plate 42 to be rotated by wind moving along the cone member 50; a third rotating gear 44 formed at the other end of the second rotating shaft 41 rotated by the second blades 43 and having the same diameter as the first rotating gear 34, and a fourth rotating gear 45 installed to be engaged with the third rotating gear 44 to rotate the power generation module 60.

The cone member 50 may include: a cone body 51 formed in a cone shape so that the wind moves toward the first blade member and the second blade member 40; a first support frame 52 installed on one side of the central fixed shaft member 20 so that the cone body 51 is stably fixed, and a second support frame 53 installed on the outer surface of the second blade member so that the cone body 51 is stably fixed 40.

### Technical Effects of the Invention

As described above, the wind power generator for street light according to the present invention can provide sufficient torque and rotation speed required for power generation by installing double blades of the first blade and the second blade, and can increase power generation time by driving the power generation module with the double blades. In addition, it is possible to minimize the installation space and reduce the size of the wind power generator by installing the first rotating shaft and the second rotating shaft in a double layer structure.

According to the wind power generator for street light of the present invention, even when wind is weak, the power generation module can generate power consistently by using the double blades and the cone member, which can move wind toward the double blades.

### BRIEF DESCRIPTION OF THE DRAWINGS

FIG. 1 is a cross-sectional perspective view illustrating a wind power generator for street light according to a preferred embodiment of the present invention.

FIG. 2 is a cross-sectional perspective view illustrating a wind power generator for street light according to a preferred embodiment of the present invention.

FIG. 3 is a magnified cross-sectional perspective view illustrating a wind power generator for street light according to a preferred embodiment of the present invention.

FIG. 4 is a magnified cross-sectional perspective view illustrating a wind power generator for street light according to a preferred embodiment of the present invention.

FIG. 5 is an exploded cross-sectional perspective view illustrating a wind power generator for street light according to a preferred embodiment of the present invention.

FIG. 6 is an exploded cross-sectional perspective view illustrating a wind power generator for street light according to a preferred embodiment of the present invention.

FIG. 7 is a cross-sectional view illustrating a wind power generator for street light according to a preferred embodiment of the present invention.

FIG. 8 is a perspective view illustrating a wind power generator for street light according to a preferred embodiment of the present invention.

FIG. 9 is a perspective view illustrating a wind power generator for street light according to a preferred embodiment of the present invention.

### BEST MODE FOR THE INVENTION

Hereinafter, a wind power generator for street light according to a preferred embodiment of the present invention will be described in detail with reference to the accompanying drawings.

The wind power generator for street light according to a preferred embodiment of the present invention comprises: a post member 10 installed vertically; a central fixed shaft member 20 installed horizontally on an upper portion of the post member 10; a first blade member 30 rotatably installed around the central fixed shaft member 20 and including a first blade 33 rotated by wind on one side thereof; a second blade member 40 rotatably installed around the first blade member 30 and including a second blade 43 rotated by wind on one side thereof; a cone member 50 having an inclined shape at a specific angle so that wind smoothly moves toward the first blade member 30 and the second blade member 40; and a power generation module 60 rotated by the first blade member 30 and the second blade member 40 to generate power.

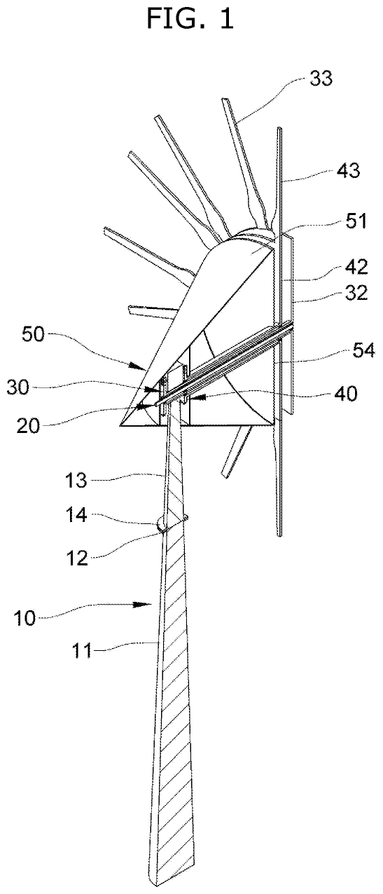

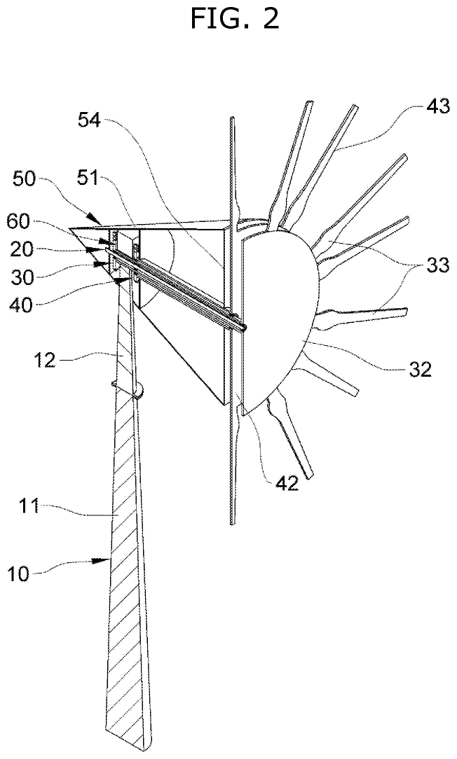

FIG. 1 is a cross-sectional perspective view illustrating a wind power generator for street light according to a preferred embodiment of the present invention. FIG. 2 is a cross-sectional perspective view illustrating a wind power generator for street light according to a preferred embodiment of the present invention.

Referring to FIGS. 1 and 2, the wind power generator for street light of the present invention comprises: the post member 10 installed at a predetermined height; the central fixed shaft member 20 installed on the upper portion of the post member 10; the first blade member 30 rotatably installed around the central fixed shaft member 20; the second blade member 40 rotatably installed around the first blade member 30; the cone member 50 installed around the first blade member 30 and the second blade member 40; and the power generation module 60 generating power by the first blade member 30 and the second blade member 40.

The post member 10 includes: a lower post 11 formed to a predetermined height; a lower flange 12 formed on a top side of the lower post 11 with a predetermined diameter; an upper post 13 installed on the top side of the lower post 11; an upper flange 14 formed on the bottom side of the upper post 13 with the same diameter as the lower flange 12, and a flange cover coupled to the outer surface of the lower flange 12 and the upper flange 14, wherein the upper post 13 is rotatably installed around the lower post 11.

The post member 10 includes the lower post 11 and the upper post 13 so that the blade members 30 and 40 are installed at a predetermined height. The lower flange 12 having a diameter larger than that of the lower post 11 is integrally formed on the top side of the lower post 11.

In addition, the upper post 13 is formed to a predetermined height, and the upper flange 14 having the same diameter as that of the lower flange 12 is formed on the bottom side of the upper post 13.

The upper post 13 is rotatably installed around the lower post 11 so as to be rotated according to the wind direction. In this case, the lower flange 12 and the upper flange 14 are installed to face each other, and the flange cover (not shown) is installed on the outer surfaces of the lower and the upper flange 12, 14.

Accordingly, since the upper post 13 rotates around the lower post 11, the first and the second blade 33, 43 can rotate regardless of the wind direction, and the power generation module 60 can be continuously driven.

A central fixed shaft member 20 is installed on the upper portion of the upper post 10 in the horizontal direction. A first bearing 21 is installed on the outer surface of the central fixed shaft member 20 so that the first blade member 30 is rotatably installed. A second bearing 22 is installed to be spaced apart from the first bearing 21 by a predetermined distance.

The first bearing 21 and the second bearing 22 are installed to enable the first blade member 30 installed around the central fixed shaft member 20 to rotate therearound.

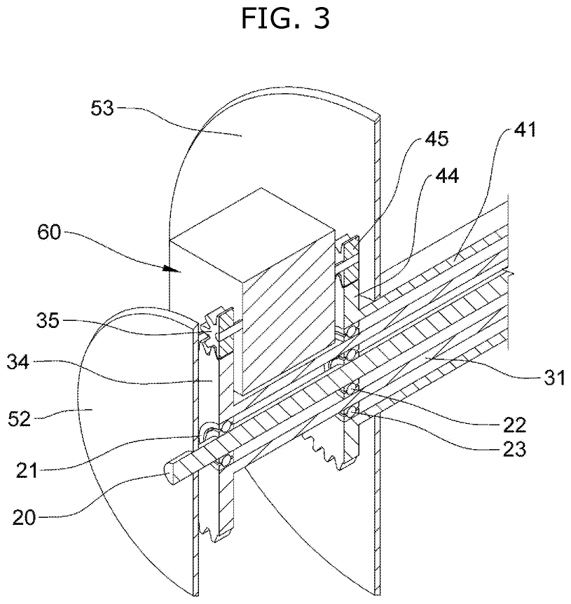

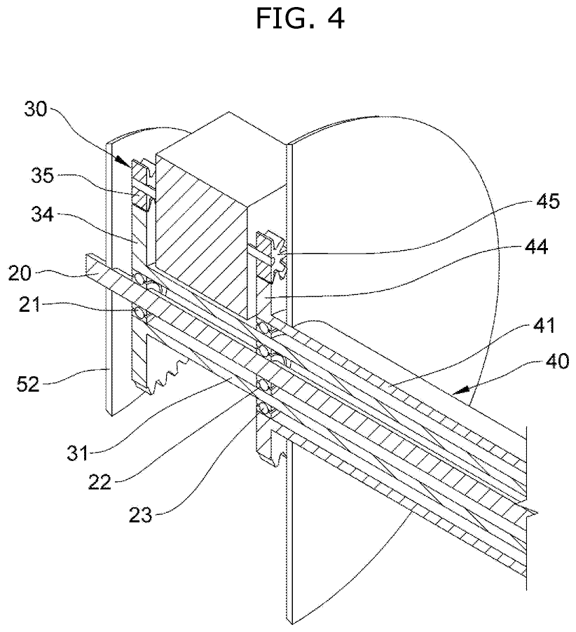

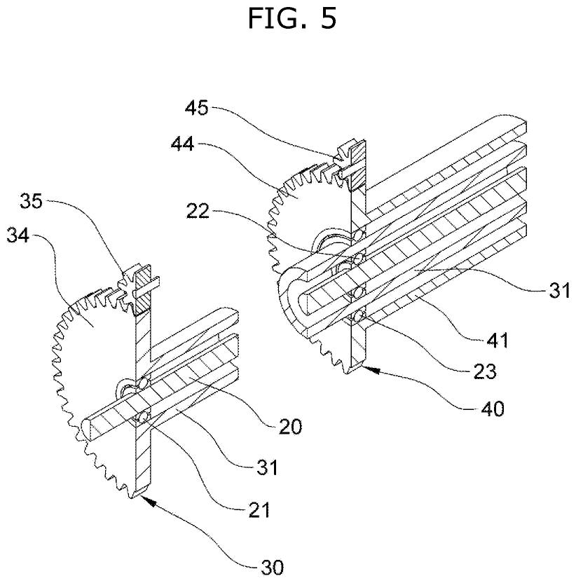

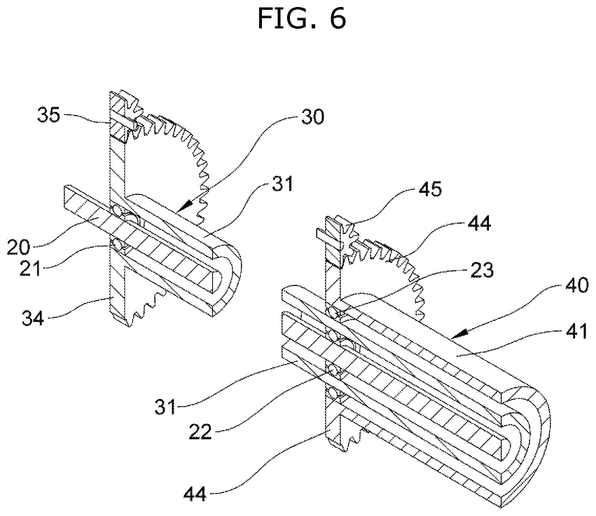

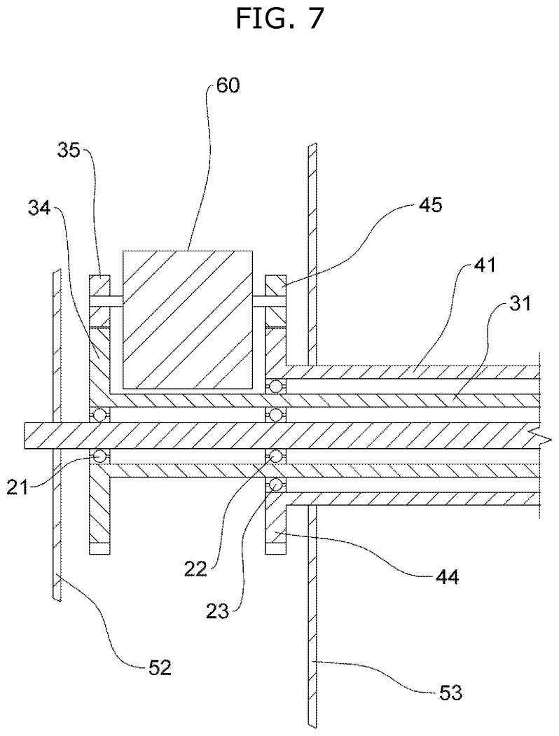

FIG. 3 is a magnified cross-sectional perspective view illustrating a wind power generator for street light according to a preferred embodiment of the present invention. FIG. 4 is a magnified cross-sectional perspective view illustrating a wind power generator for street light according to a preferred embodiment of the present invention. FIG. 5 is an exploded cross-sectional perspective view illustrating a wind power generator for street light according to a preferred embodiment of the present invention. FIG. 6 is an exploded cross-sectional perspective view illustrating a wind power generator for street light according to a preferred embodiment of the present invention. FIG. 7 is a cross-sectional view illustrating a wind power generator for street light according to a preferred embodiment of the present invention.

Referring to FIGS. 1 to 7, the first blade member 30 includes: a first rotating shaft 31 rotatably installed around the central fixed shaft member 20; a first rotating plate 32 formed of a disk having a predetermined diameter at one end of the first rotating shaft 31; multiple first blades 33 formed to protrude from the outer circumference of the first rotating plate 32 to be rotated by wind moved along the cone member 50; a first rotating gear 34 formed at the other end of the first rotating shaft 31 rotated by the first blades 33; and a second rotating gear 35 installed to be engaged with the first rotating gear 34 to rotate the power generation module 60.

The first blade member 30 is rotated by wind, and the first rotating shaft 31 formed in a hollow cylindrical shape is rotatably installed around the central fixed shaft member 20.

The first rotating shaft 31 is formed in a hollow cylindrical shape to be coupled to the outside of the central fixed shaft member 20, and the first bearing 21 and the second bearing 22 are installed between the central fixed shaft member 20 and the first rotating shaft 31.

In addition, the first rotating plate 32 formed of a disk having a predetermined diameter is formed at one end of the first rotating shaft 31, and the first blade 33 rotated by wind is installed on the outer circumference of the first rotating plate 32.

In this case, as described above, the first blades 33 is plural, and the plurality of the first blades 33 are installed on the first rotating plate 32.

The first rotating gear 34 rotated by the first blades 33 is installed at the other end of the first rotational shaft 31, and the second rotating gear 35 is installed in gear with the first rotating gear 34.

The second rotating gear 35 rotates the power generation module 60 to generate power.

Meanwhile, the second blade member 40 is rotatably installed around the first blade member 30.

The second blade member 40 includes: a second rotating shaft 41 rotatably installed around the first rotating shaft 31; a second rotating plate 42 formed of a disk having a predetermined diameter at one end of the second rotating shaft 41; a plurality of second blades 43 formed to protrude from the outer circumference of the second rotating plate 42 to be rotated by wind moving along the cone member 50; a third rotating gear 44 formed at the other end of the second rotating shaft 41 rotated by the second blades 43 and having the same diameter as the first rotating gear 34, and a fourth rotating gear 45 installed to be engaged with the third rotating gear 44 to rotate the power generation module 60.

The second blade member 40 rotates the power generation module 60 together with the first blade member 30 to generate power, and the second blade member 40 is installed around the first blade member 30.

The second rotating shaft 41 is formed in a hollow cylindrical shape, and the second rotating plate 42 having a predetermined diameter is formed at one end of the second rotating shaft 41. The second blade 43 rotated by wind is installed on the outer circumference of the second rotating plate 42.

In this case, as described above, the second blade 43 is plural, and the plurality of the second blades 43 are installed on the second rotating plate 42.

In addition, a third bearing 23 is installed between the second rotating shaft 41 and the first rotating shaft 31 to allow the second rotating shaft 41 to rotate separately from the first rotating shaft 31.

The third rotating gear 44 is formed at the other end of the second rotating shaft 41. The fourth rotating gear 45 is in gear with the third rotating gear 43 to rotate the power generation module 60 and thus generate power.

Meanwhile, it is preferable that the first blade 33 is formed to have a length relatively longer than that of the second blade 43.

The cone member 50 is installed on one side of the first blade member 30 and the second blade member 40 so that the wind moves toward the first and the second blade 33, 43.

The cone member 50 includes: a cone body 51 formed in a cone shape so that the wind moves toward the first blade member 30 and the second blade member 40; a first support frame 52 installed on one side of the central fixed shaft member 20 so that the cone body 51 is stably fixed, and a second support frame 53 installed on the outer surface of the second blade member so that the cone body 51 is stably fixed 40.

The cone body 51 is formed in a cone shape so that the wind moves toward the first and the second blade 33, 43 along the cone body 51 regardless of the wind direction. Accordingly, the first blade member 30 and the second blade member 40 are rotated by wind.

In order to stably fix the cone body 51, the first support frame 52 and the second support frame 53 is respectively installed on the central fixed shaft member 20 and on the outer surface of the second blade member 40 inside the cone body 51.

In addition, a third support frame 54 is installed at the end of the cone body 51 so that the central fixed shaft member 20 can be installed more stably. The central fixed shaft member 20 is installed on the outer surface of the cone body 51.

Meanwhile, the power generation module 60 generating power is installed between the second rotating gear 35 of the first blade member 30 and the fourth rotating gear 45 of the second blade member 40.

Hereinafter, according to a preferred embodiment of the present invention, a method of operating a wind power generator for street light will be described with reference to FIGS. 1 to 9.

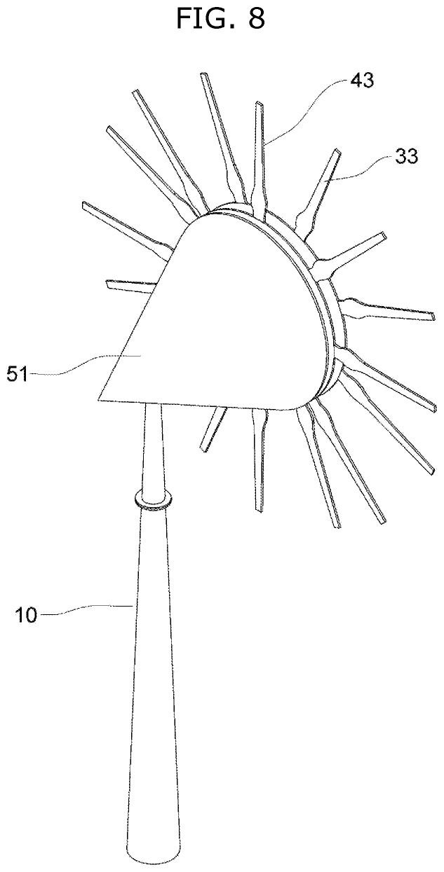

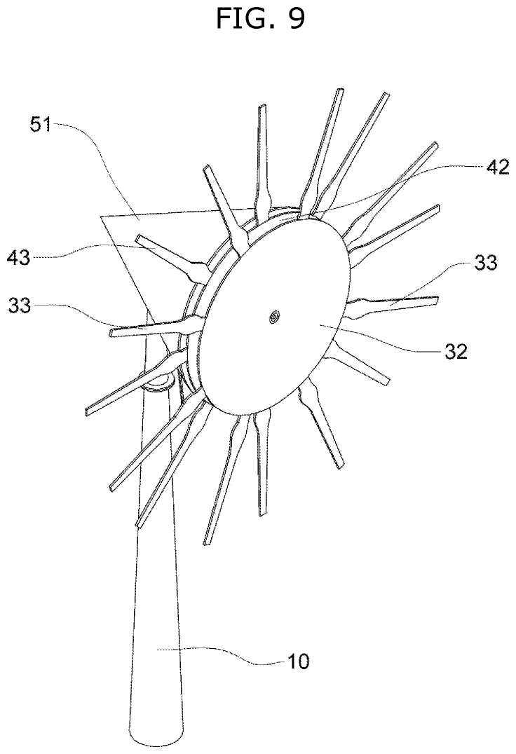

FIG. 8 is a perspective view illustrating a wind power generator for street light according to a preferred embodiment of the present invention. FIG. 9 is a perspective view illustrating a wind power generator for street light according to a preferred embodiment of the present invention.

Referring to FIGS. 1 to 9, the wind power generator for street light of the present invention includes the first blade member 30, which is installed around the central fixed shaft member 20 and rotated by the first blade 33, and the second blade member 40, which is installed around the first blade member 30 and rotated by the second blade 43. The first blade member 30 and the second blade member 40 are formed in a double lap structure.

The first blade member 30 and the second blade member 40 are installed at an appropriate height by the post member 10, which is composed of the lower post 11 and the upper post 13. The upper post 13 is installed to be rotatable according to the wind direction.

In addition, since the cone body 51 is installed around the first blade member 30 and the second blade member 40, the first blade 33 and the second blade 43 can be supplied with a sufficient amount of air to rotate even when wind is weak.

That is, the cone body 51 allows wind to move toward the first and the second blade 33, 43 along the outer surface of the cone body 51, thereby rotating the first and the second blade 33, 43.

As the first blade 33 of the first blade member 30 is rotated by wind, the first rotating shaft 31 and the first rotating gear 34 formed on the first rotating shaft 31 rotate.

The first rotating gear 34 rotates the second rotating gear 35, and thus, the power generation module 60 generates power by the rotation of the second rotating gear 35.

In addition, the second blade 43 of the second blade member 40 is rotated by wind, and the second rotating shaft 41 and the third rotating gear 44 are rotated by the second blade 43.

The third rotating gear 44 rotates the fourth rotating gear 45 coupled to the power generation module 60, and thus, the power generation module 60 generates power.

Accordingly, the double blades of the first blade member 30 and the second blade member 40 can supply sufficient torque required for the rotation of the power generation module 60, and can generate power by rotating the power generation module 60 at high speed.

In addition, since the cone member 50 moves wind toward the first and the second blade 33, 43, power can be consistently generated even when wind is weak.

Although the invention made by the present inventor has been described in detail according to the above embodiment, the present invention is not limited to the embodiment and various modifications can be made without departing from the gist of the present invention.

What is claimed is:

1. A wind power generator for street light comprising:
a post member 10 installed vertically;
a central fixed shaft member 20 installed horizontally on an upper portion of the post member 10;
a first blade member 30 rotatably installed around the central fixed shaft member 20 and including a first blade 33 rotated by wind on one side thereof;
a second blade member 40 rotatably installed around the first blade member 30 and including a second blade 43 rotated by wind on one side thereof;
a cone member 50 having an inclined shape at a specific angle so that wind smoothly moves toward the first blade member 30 and the second blade member 40, and
a power generation module 60 rotated by the first blade member 30 and the second blade member 40 to generate power,
wherein the cone member 50 includes:
a cone body 51 formed in a cone shape so that the wind moves toward the first blade member 30 and the second blade member 40;
a first support frame 52 installed on one side of the central fixed shaft member 20 so that the cone body 51 is stably fixed, and
a second support frame 53 installed on an outer surface of the second blade member so that the cone body 51 is stably fixed 40.

2. The wind power generator for street light of claim 1, wherein the post member 10 includes:
a lower post 11 formed to a predetermined height;
a lower flange 12 formed on a top side of the lower post 11 with a predetermined diameter;
an upper post 13 installed on the top side of the lower post 11;
an upper flange 14 formed on a bottom side of the upper post 13 with the same diameter as the lower flange 12, and
a flange cover coupled to an outer surface of the lower flange 12 and the upper flange 14,
wherein the upper post 13 is rotatably installed around the lower post 11.

3. The wind power generator for street light of claim 1, wherein the first blade member 30 includes:
a first rotating shaft 31 rotatably installed around the central fixed shaft member 20;
a first rotating plate 32 formed of a disk having a predetermined diameter and installed at one end of the first rotating shaft 31;
a plurality of the first blades 33 formed to protrude from an outer circumference of the first rotating plate 32 to be rotated by wind moving along the cone member 50;
a first rotating gear 34 formed at the other end of the first rotating shaft 31 rotated by the first blades 33, and
a second rotating gear 35 installed to be engaged with the first rotating gear 34 to rotate the power generation module 60.

4. The wind power generator for street light of claim 3, wherein the second blade member 40 includes:
a second rotating shaft 41 rotatably installed around the first rotating shaft 31;
a second rotating plate 42 formed of a disk having a predetermined diameter and installed at one end of the second rotating shaft 41;
a plurality of second blades 43 formed to protrude from an outer circumference of the second rotating plate 42 to be rotated by wind moving along the cone member 50;
a third rotating gear 44 formed at the other end of the second rotating shaft 41 rotated by the second blades 43 and having the same diameter as the first rotating gear 34, and
a fourth rotating gear 45 installed to be engaged with the third rotating gear 44 to rotate the power generation module 60.
